(19) United States
(12) Patent Application Publication
(10) Pub. No.: US 2012/0301215 A1
(43) Pub. Date: Nov. 29, 2012

(54) ADAPTER

(76) Inventor: Sz-Lung HUANG, (US)

(21) Appl. No.: 13/567,241

(22) Filed: Aug. 6, 2012

Related U.S. Application Data
(63) Continuation-in-part of application No. 12/700,722, filed on Feb. 5, 2010.

(51) Int. Cl. F16B 7/18

(52) U.S. Cl. 403/176

(57) ABSTRACT

An adapter includes a main body, at least one jointer and at least one screw. The main body is a hexahedron and has six combining surfaces. Each of the combining surfaces is formed with at least one threaded bore. The jointer is adapted for an extender to connect thereto, and the jointer has an abutting surface to attach to one of the combining surfaces. An area of the abutting surface is not larger than an area of its corresponding combining surface. The abutting surface has at least one through bore corresponding to the at least one threaded bore. The screw is extended through the through bore and threaded with the threaded bore to detachably fix the jointer with the main body.

The present invention is a CIP of application Ser. No. 12/700,722, filed Feb. 5, 2010, the entire contents of which are hereby incorporated by reference.

### BACKGROUND OF THE INVENTION

1. Field of the Invention

2. Description of the Prior Art

Welding manner is commonly used to combine tubes of a frame. Nevertheless, once the tubes are welded, they cannot be disassembled easily. Besides, the welded surfaces are uneven and darkened, and the welding touch is too dangerous for an untrained user to weld the tubes on his own.

Some adapters are provided to simplify the combination procedure, but conventional adapters usually have disadvantages of complex structure, high cost and non-unified standard.

For instance, TW M295700 discloses an adapter for a laboratory table. The adapter includes a main body being formed with several cubical mounting portions on different surfaces of the main body, so that tubes can mount with the mounting portions respectively. However, adapters with different numbers of mounting portion should be individually formed, which may lead to the upsurge of the molding cost and the inconvenience to storage adapters with different numbers of mounting portion. Also, if an adapter with specific number of mounting portion is missing during the combination procedure, the frame may not be successfully assembled.

TW M349974 discloses another adapter. The adapter is adapted to be directly installed on a tube, and another tube can, therefore, be mounted with such adapter. To install the adapter on the tube, several threaded bores should be drilled on the tube. However, a drill is still too dangerous for an untrained user. To precisely drill the threaded bores at correct positions is yet another problem for the user. Also, side walls of such tubes will be damaged due to the drilling. As such, even if the tubes can be disassembled, they will have authentic defects that may not satisfy the user's need.

EP 0344120 A1 discloses that a washer (not a jointer) to be sandwiched between a furniture part and a cube. The furniture part is a solid rod member and abuts against the washer but not against the cube. The washer is not received in the furniture part, the furniture part and cube are connected via a long and thin pin, and the washer is smaller than the furniture part and cube in size, such that the structural strength of the combination thereof is poor.

FR 2667656-A1 discloses that a jointer has a open side for disposing plural bolts therein, and each of the bolts is mounted into the jointer with its head portion blocked by and abutted against the inner wall surface and its threaded portion extending through one of a through bore, such that it is impossible to secure a tubular member or an extender to the open side of the jointer (as shown in FIG. 4 of FR 2667656-A1). Besides, a flexible and deformable material is disposed between a washer and the jointer, and the flexible and deformable material is deformed broadside against the inner sidewall of a tube (as shown in FIG. 7 of FR 2667656-A1). Since the tube and the jointer are combined via the flexible and deformable material, the connection thereof is unstable and the structural strength of the combination thereof is poor.

Therefore, the present invention is arisen to obviate or at least mitigated the above-mentioned disadvantages.

### SUMMARY OF THE INVENTION

The main object of the present invention is to provide a simplified adapter that can be easily assembled.

To achieve the above and other objects, an adapter of the present invention includes a main body, at least one jointer and at least one screw. The main body is a hexahedron and has six combining surfaces. Each of the combining surfaces is formed with at least one threaded bore. The jointer is adapted for an extender to connect thereto, and the jointer has an abutting surface to attach to one of the combining surfaces. An area of the abutting surface is not larger than an area of its corresponding combining surface. The abutting surface has at least one through bore corresponding to the at least one threaded bore. The screw is extended through the through bore and threaded with the threaded bore to detachably fix the jointer with the main body. The jointer is received in the extender, and the extender abuts against one of the combining surfaces of the main body.

Thereby, the user can freely assemble the extenders into desired figure with the help of the adapters of the present invention. The extenders can still be disassembled, and the adapters can be recycled. Due to the single standard of the main body, the adapter can be used in various occasions. That is, the adapter of the present invention has advantages such as low cost, easy operability and high degree of freedom of combination.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a breakdown drawing showing a first embodiment of the present invention assembled with extenders;

FIG. 2 is a combination drawing showing a first embodiment of the present invention assembled with extenders;

FIG. 3 is a breakdown drawing showing a first embodiment of the present invention;

FIG. 4 is a combination drawing showing a first embodiment of the present invention;

FIG. 5 is a breakdown drawing showing a first embodiment of the present invention assembled with extenders;

FIG. 6 is a partial breakdown drawing showing a first embodiment of the present invention assembled with extenders;

FIG. 7 is a combination drawing showing a first embodiment of the present invention assembled with extenders;

FIG. 8 is a partial breakdown drawing showing a second embodiment of the present invention assembled with extenders;

FIG. 9 is a breakdown drawing showing a third embodiment of the present invention assembled with extenders;

FIG. 10 is a partial breakdown drawing showing a third embodiment of the present invention assembled with extenders;

FIG. 11 is a partial breakdown drawing showing a second embodiment of the present invention assembled with extenders;

FIG. 12 is a partial breakdown drawing showing a second embodiment of the present invention assembled with extenders.

### DETAILED DESCRIPTION OF THE PREFERRED EMBODIMENTS

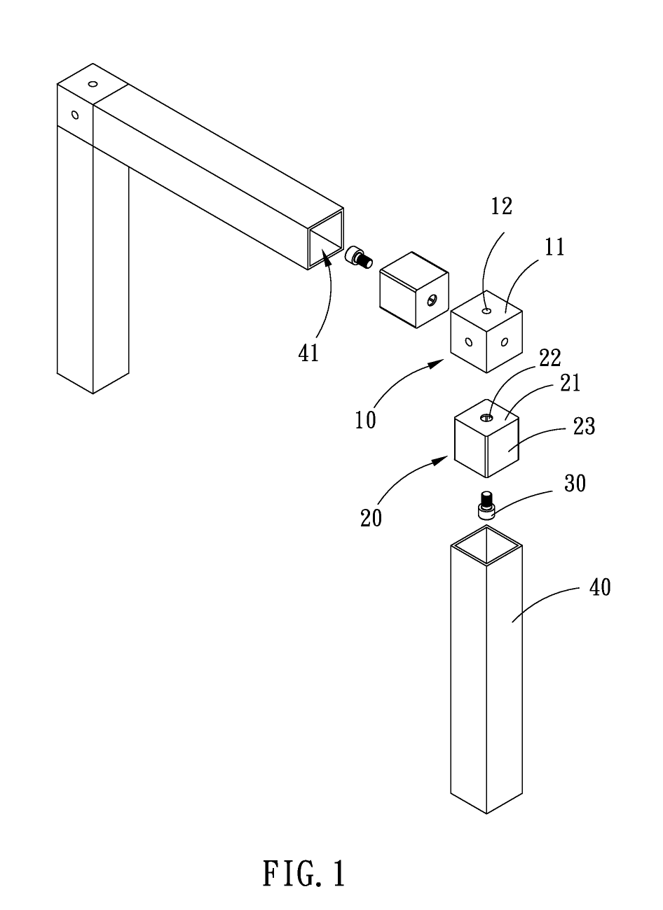

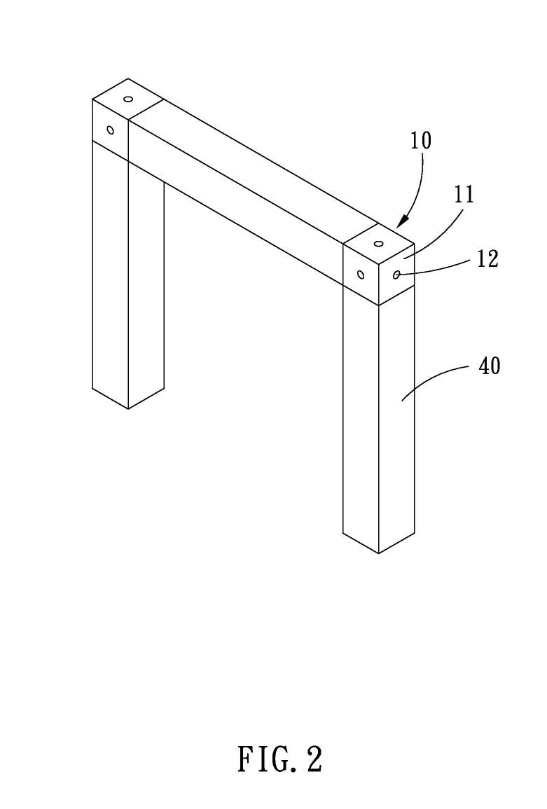

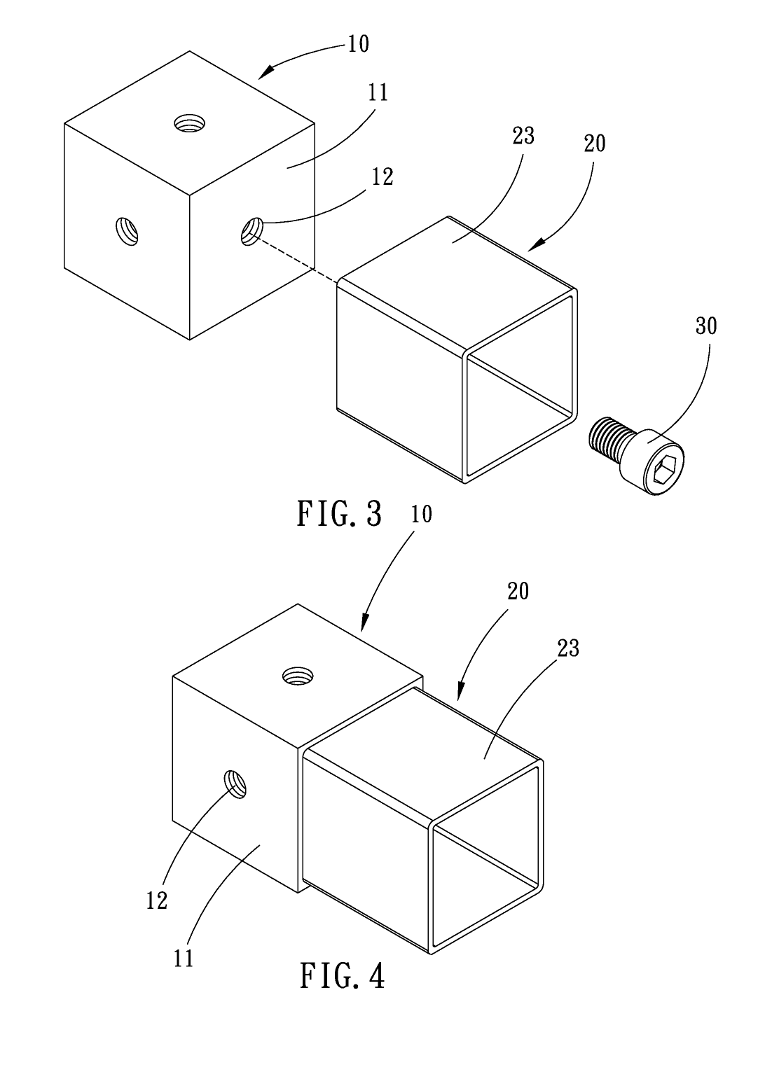

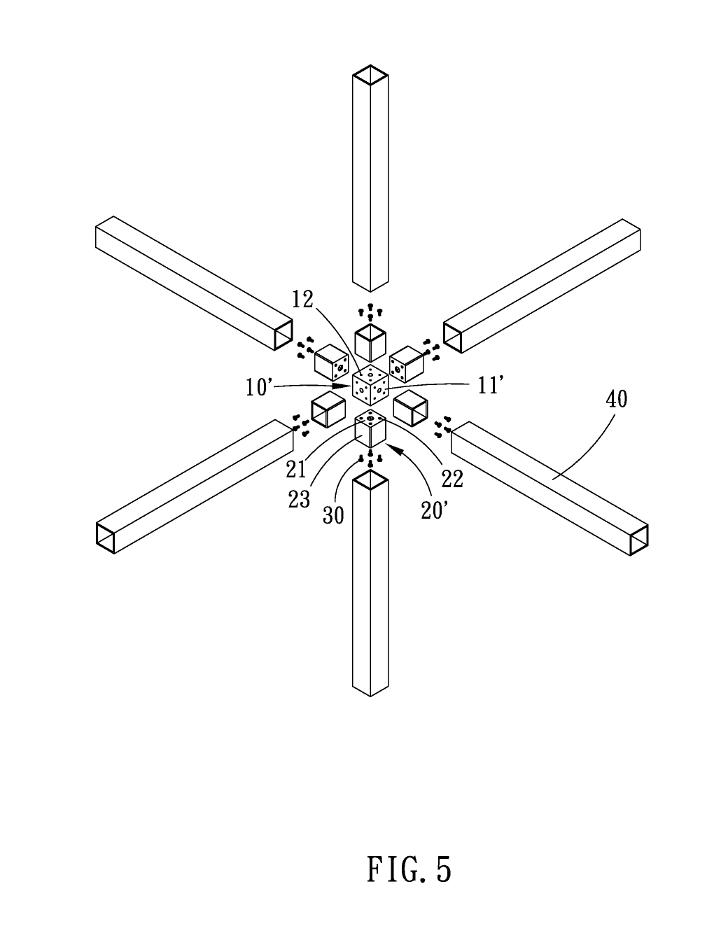

Please refer to FIG. 1 to FIG. 4 for the first embodiment of the present invention. The adapter of the present embodiment includes a main body 10, at least one jointer 20 and at least one screw 30.

The main body 10 is a hexahedron and has six combining surfaces 11. Preferably, the main body 10 is a regular hexahedron. Each of the combining surfaces 11 is formed with at least one threaded bore 12.

The jointer 20 is adapted for an extender, such as a tube 40 to connect thereto. In this embodiment, the jointer 20 is received in the extender, and the extender abuts against one of the combining surfaces 11 of the main body 10. The number of the jointer 20 corresponds to that of the tube 40 to be assembled. The jointer 20 has an abutting surface 21 to attach to one of the combining surfaces 11. An area of the abutting surface 21 is not larger than an area of its corresponding combining surface 11. The abutting surface 21 has at least one through bore 22 corresponding to the threaded bore 12. The number of the through bore 22 of an abutting surface 21 is preferably equal to that of the threaded bore 12 of its corresponding combining surface 11. In the present embodiment, the jointer 20 is a hollow polyhedron, and the jointer 20 has an open end opposite to the abutting surface 21. The abutting surface 21 is a rectangle, preferably a square. The jointer 20 has four rectangular side walls extending from edges of the abutting surface 21 respectively, and the four side walls are perpendicular to the abutting surface 21. The jointer 20 forms a receiving room enclosed by the abutting surface 21 and four side walls of the jointer 20, and the through bore 22 and the open end communicate with the receiving room. Further, the tube 40 has a tetragon bore 41 corresponding to the contour of the jointer 20 so that the tube 40 can mount with the jointer 20. Preferably, the outer surfaces of the tube 40 flush with the main body once the tube 40 mounts with the jointer 20. Side surfaces 23 of the jointer 20 abut against the inner side surfaces of the tube 40.

The number of the screw 30 corresponds to that of the threaded bore 12. The screw 30 is extended through the through bore 22 and then threaded with the threaded bore 12 to detachably fix the jointer 20 with the main body 10. Preferably, the screw 30 enters the receiving room through the open end of the jointer 20 and is extended in the through bore 22.

In the present invention, the jointer 20 is received in the extender (the tube 40), all the side surfaces 23 of the jointer 20 can abut against the inner side surfaces of the extender, and the extender abuts against one of the combining surfaces 11 of the main body 10, which can enhance the structural strength of the combination of the jointer 20 and the extender.

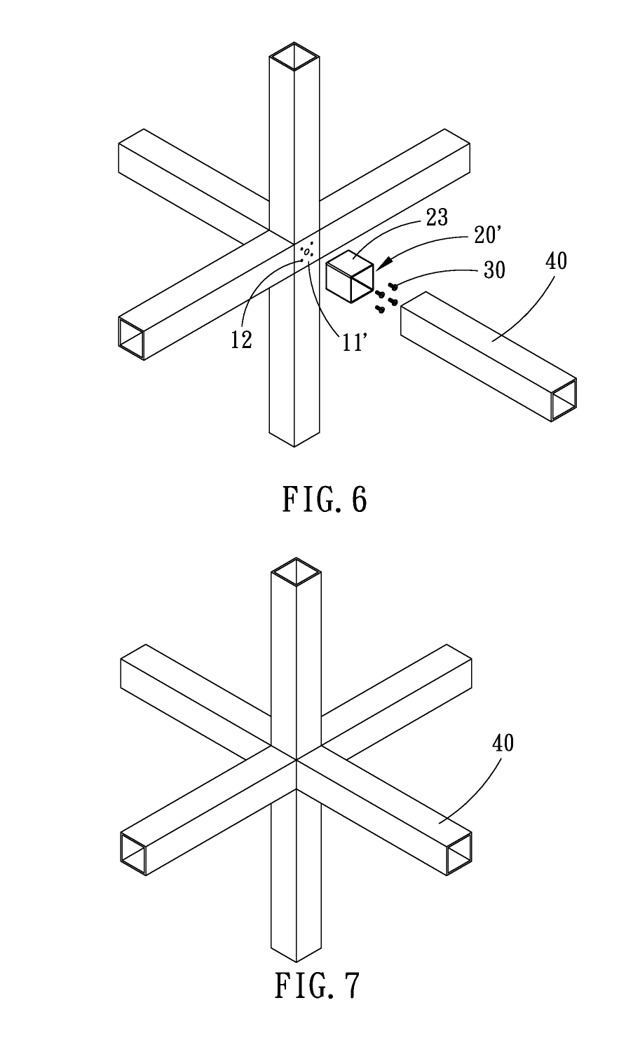

As shown in FIG. 5 to FIG. 7, each and every combination surface 11′ of the main body 10′ is attached with a tube 40. That is, six jointers 20′ are needed and are attached to the combination surfaces 11′ respectively. Thus the combination procedure can be finished easily.

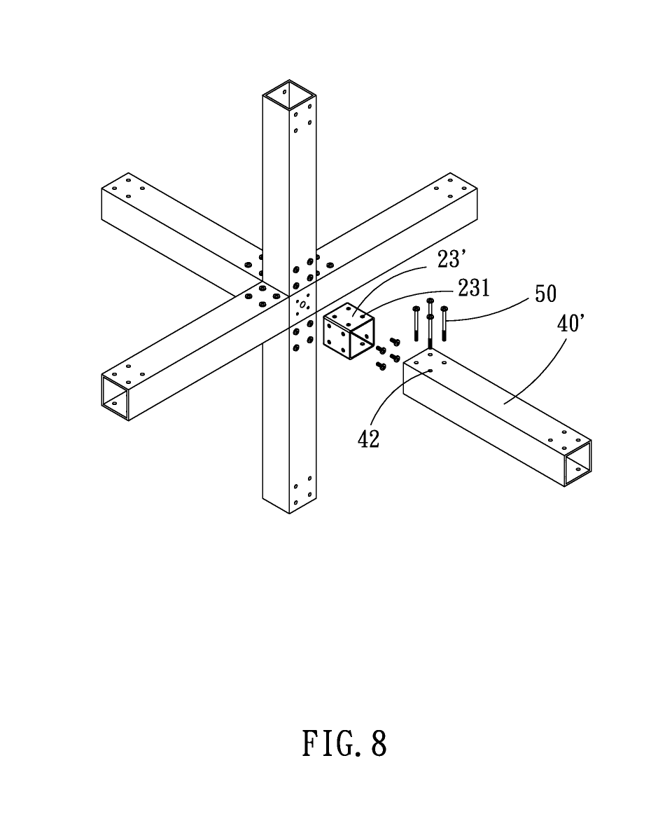

The tube 40 and the jointer 20 can be fixed and mounted with each other by friction. Or, the jointer of the second embodiment of the present invention has four side surfaces 23′, at least one of which is formed with at least one threaded bore 231, as shown in FIG. 8. The tube 40′ is also formed with through bores 42, so that screws 50 can insert through the through bores 42 and be threaded with the threaded bores 231 respectively. The through bores 42 and the threaded bores 231 are preferably formed by the manufacturer. Thus the drilling process is not necessary when the user assembles the tubes with the adapters.

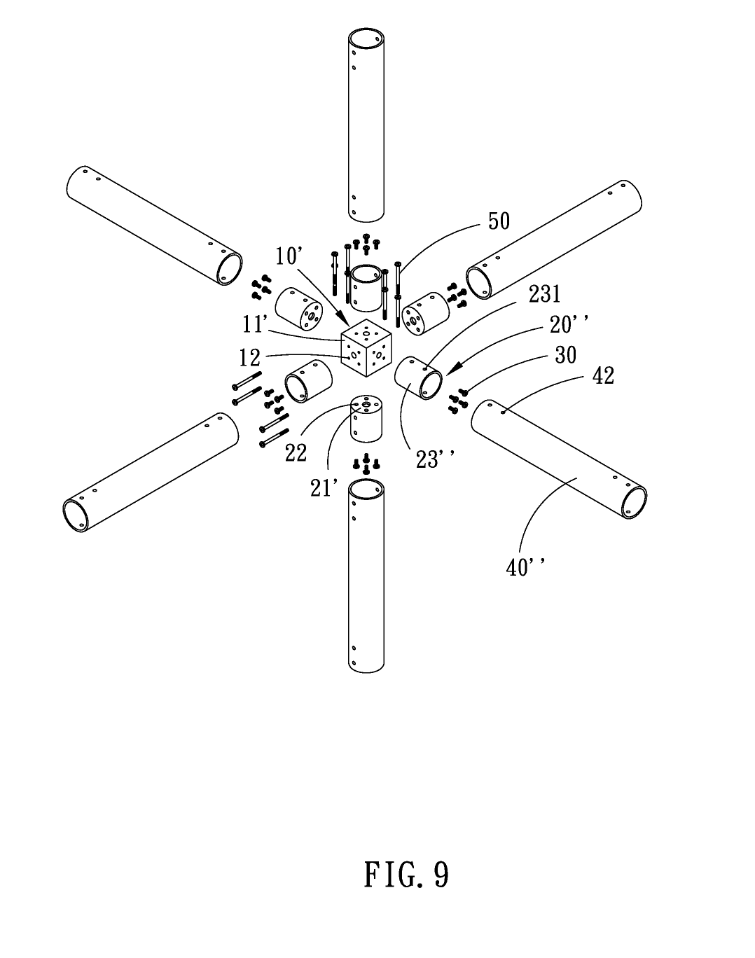

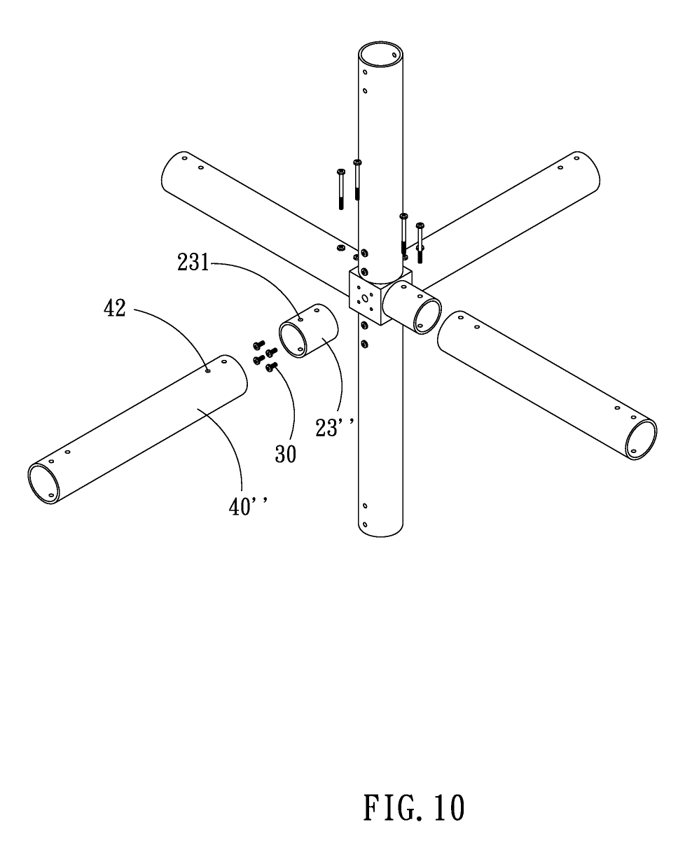

Please refer to FIG. 9 and FIG. 10 for a third embodiment of the present invention. The jointer 20″ is a hollow cylinder, and the extender is a cylindrical tube 40″. That is to say, the main body 10′ is adapted for extenders with different shapes by choosing jointers with desired shapes. Thus the main body 10′ can still have single standard which can lower the molding cost. Further, the cylinder jointer 20″ has a side surface 23″ surrounding the abutting surface 21′, and the side surface 23″ can also be formed with threaded bores for the extender to threadedly connect thereto.

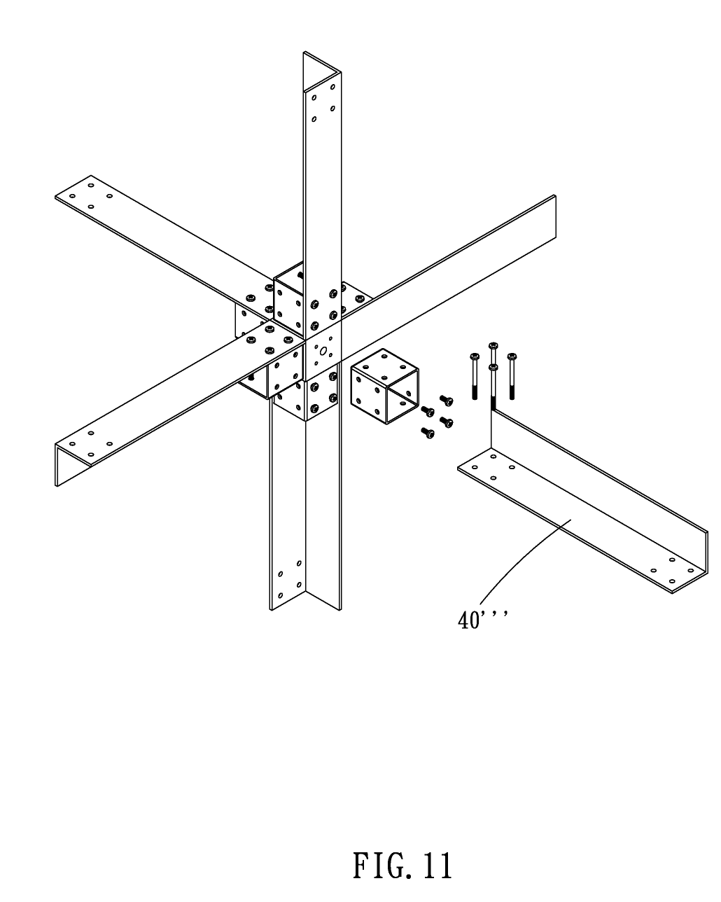

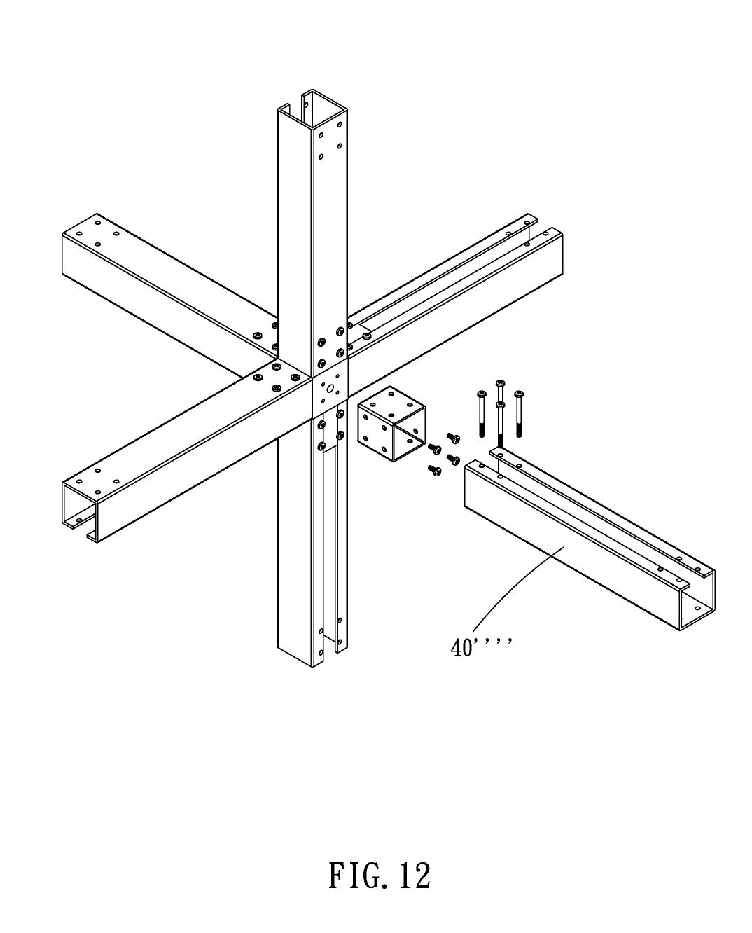

In the present invention, the shape of the extender is variable. For instance, the extender can simply be two plates fixed together as shown in FIG. 11, or the extender may be formed with a longitudinal groove at one side surface thereof, as shown in FIG. 12.

It is to be noted that one of the combining surface of the main body can be slanted to its adjacent combining surfaces, such that an extender attached on that surface can be slanted with respect to the other extenders.

What is claimed is:

1. An adapter, comprising:
a main body, being a hexahedron and having six combining surfaces, each of the combining surfaces being formed with at least one threaded bore;
at least one jointer, being adapted for an extender to connect thereto, the jointer being a hollow polyhedron, the jointer having an abutting surface to attach to one of the combining surfaces, an area of the abutting surface being not larger than an area of its corresponding combining surface, the abutting surface having at least one through bore corresponding to the at least one threaded bore, the jointer also having an open end opposite to the abutting surface, the abutting surface being a rectangle, the jointer having four side walls extending from edges of the abutting surface respectively, the four side walls being perpendicular to the abutting surface, the jointer forming a receiving room enclosed by the abutting surface and the four side walls of the jointer, the through bore and the open end communicating with the receiving room; and
at least one screw, entering the hollow jointer through the open end of the jointer and being extended through the through bore and threaded with the threaded bore to detachably fix the jointer with the main body, wherein the jointer is received in the extender, and the extender abuts against one of the combining surfaces of the main body.

2. The adapter of claim 1, wherein the jointer has four side surfaces, at least one of the side surfaces is formed with at least one threaded bore for the extender to threadedly connect thereto.

3. The adapter of claim 1, wherein the main body is a regular hexahedron.
